(19) United States
(12) Patent Application Publication
(10) Pub. No.: US 2023/0058504 A1
(43) Pub. Date: Feb. 23, 2023

(54) SECURING A SECOND OBJECT TO A FIRST OBJECT

(71) Applicant: MULTIMATERIAL-WELDING AG, Biel/Bienne (CH)

(72) Inventors: Joakim KVIST, Nidau (CH); Murat TUNCER, Morges (CH); Jörg MAYER, Niederlenz (CH)

(21) Appl. No.: 17/792,323

(22) PCT Filed: Jan. 14, 2021
(86) PCT No.: PCT/EP2021/050690

§ 371 Date: Jul. 12, 2022

(30) Foreign Application Priority Data
Jan. 14, 2020 (CH) 00047/20

(51) Int. Cl. B29C 65/56; B29C 65/48; B29C 65/00; F16B 11/00

(52) U.S. Cl. CPC B29C 65/562; B29C 65/48; B29C 66/742; B29C 66/73921; F16B 11/006

(57) ABSTRACT

The method of bonding a first object (1) to a second object (2) uses a connector, the connector having a first sheet portion and a second sheet portion (32). The first sheet portion has at least one outwardly protruding first attachment portion (33), and the second sheet portion has at least one outwardly protruding second attachment portion (34). The connector (3) further has a spacer between the first and second sheet portions. For bonding, the first and second objects (1, 2) and the connector (3) are positioned relative to each other so that the connector is placed between the first and second objects. Then the first and second objects (1, 2) are pressed against each other while mechanical vibration energy impinges on the first and/or second object until a first flow portion of thermoplastic material of the first object in contact with the first attachment portion(s) and a second flow portion of thermoplastic material in contact with the second attachment portion(s) become flowable allowing the respective attachment portions (33, 34) to be pressed into material of the first and second object, respectively. After re-solidification of the flow portions, a positive-fit connection between the first and second objects via the connector results. The spacer defines a width (w) of a gap between the first and second objects (1, 2) after bonding.

### FIELD OF THE INVENTION

The invention is in the fields of mechanical engineering and construction, especially mechanical construction, for example automotive engineering, aircraft construction, railway industry, shipbuilding, machine construction, toy construction, building industries, etc. In particular, it relates to a method of - mechanically - securing a second object to a first object.

### BACKGROUND OF THE INVENTION

In the automotive, aviation and other industries, there has been a tendency to move away from steel-only constructions and to use lightweight material such as aluminum or magnesium metal sheets or polymers, such as carbon fiber reinforced polymers or glass fiber reinforced polymers or polymers without reinforcement, for example polyesters, polycarbonates, etc. instead.

The new materials cause new challenges in bonding elements of these materials.

To meet these challenges, the automotive, aviation and other industries have started heavily using adhesive bonds. Adhesive bonds can be light and strong. However, adhesive bonds may lead to a rise in manufacturing cost, both, because of material cost and especially because of delays caused in manufacturing processes due to slow hardening processes. The manufacturing process for a certain part essentially has to be interrupted until the adhesive connection has sufficiently hardened before a next process step can begin. Therefore, in a manufacturing line, an intermediate store has to be provided for hardening parts.

For example in WO 2018/130 524 it has been proposed to combine an adhesive connection between two objects having thermoplastic material with a connection via a profile body. For fastening, both, the profile body and an adhesive are placed between the objects. The objects then are pressed against each other while mechanical energy impinges on at least one of the objects, until the thermoplastic material becomes flowable and the profile body is embedded in both objects. This embedding of the profile body in both objects secures, after re-solidification of the thermoplastic material, the objects to each other at the position of the profile body. The adhesive that will be present at other positions between the objects may then harden subsequently while the assembly of the two objects is subject to further processing steps.

For making sure that there is an adhesive gap for the adhesive, WO 2018/130 524 firstly proposes to provide indentations in the surface of the first object and/or the second object and to dispense the adhesive in these indentations. This ensures that the adhesive gap has well-defined dimensions but may require additional manufacturing steps for providing the indentations. Alternatively, WO 2018/130 524 suggests to shape the portions that are to be embedded in the object material in a manner that the mechanical resistance rises during the process so that the embedding will stop while there is still a considerable distance between the object surfaces thereby yielding an adhesive gap. This, however, has the disadvantage that the exact distance, i.e. the exact width of the adhesive gap may be poorly defined.

The necessity of there being a gap with a well-defined width between two objects bonded to each other may also arise in situations other than the situation in which the gap is used for an adhesive. Examples include the placement of sealing means, the compensation of variations due to inaccuracies in manufacturing processes, compensation of different thermal expansion between different parts, or the requirement of there being such gap of other constructional reasons.

### SUMMARY OF THE INVENTION

It is an object of the present invention to provide a bonding method that overcomes drawbacks of prior art bonding methods, especially in terms of reliability and/or manufacturing cost. It is also an object to provide a connector to be used in such method.

In accordance with an aspect of the invention, a method of bonding a first object and a second object together is provided.

The method firstly comprises the step of providing a connector, the connector having a first sheet portion and a second sheet portion. The first sheet portion has a first outer (large) surface and a first inner (large) surface and the second sheet portion has a second outer (large) surface end a second inner (large) surface, the first and second inner surfaces facing each other. The first sheet portion has at least one outwardly protruding first attachment portion, with the sheet portion being locally bent towards outwardly and forming an edge that especially may face towards outwardly. In analogy, the second sheet portion has at least one outwardly protruding second attachment portion where the sheet portion is locally bent towards outwardly and forms an edge that especially may face towards outwardly. The respective attachment portions may be formed around openings (perforations) in the first/second sheet portion, respectively.

The connector further has a spacer between the first and second sheet portions. Such spacer comprises a spacer portion of the first and/or second sheet portion, i.e. a part of the first/second sheet portion that is bent to lie inwardly of a first/second sheet plane. More in concrete, the first sheet portion and the second sheet portion define parallel sheet planes, and the first sheet portion and/or the second sheet portion has/have a part that is bent inwardly to protrude into a space between the first and second sheet portion planes and to abut material of the respective other sheet portion. The part that defines the spacer portion may abut against the plane part of the other sheet portion, or it may abut against a spacer portion of the other sheet portion so that the abutting spacer portions together define the spacer..

In a group of embodiments, the spacer portion is bent to have an angle of about 90° with respect to the sheet portions.

In another group of embodiments, the spacer portion comprises an embossed (stamped) portion of the sheet portion.

In embodiments, the spacer portions are embossed indentations having a for example round shape (in section parallel to the sheet planes) or an other shape with rounded features, such as a polygon with rounded corners. Two such indentations of the first and second sheet portions, respectively, at corresponding positions may together define a pot spacer.

Embodiments that combine embossed spacer portions with folding the connector of a metal sheet into a spacer having the first and second sheet portions feature the substantial advantage that the punching/deformation step for the (outwardly) protruding attachment portion on the one hand and the embossing step for the inwardly protruding embossed spacer portions on the other hand each have to be made from one side only prior to folding. This is in contrast to embodiments of the prior art with one single sheet having attachment portions protruding to both sides, where punching has to be carried out from two sides.

The connector may in addition or possibly as a first alternative comprise a spacer sheet portion connected to the first and/or second sheet portion, such spacer sheet portion being bent to lie parallel to the first and second sheet portions. It may in addition or possibly as a further alternative comprise a separate spacer object.

If the spacer comprises a spacer portion of the first and/or second sheet portion, such spacer portion may be arranged at an in-plane position that is central. Then, the first/second sheet portion may be locally disrupted, for example by the spacer portion being cut out of the first/second sheet portion. In addition or as an alternative a spacer portion may be formed by bending a peripheral feature of the first/second sheet portion in a manner that it lies between the first and second sheet portions.

In accordance with a further aspect of the invention, the connector has a self-stabilizing configuration. This means that the connector has a structure in which after the bonding process the presence of the bonded first and/or second object attached to the connector prevents unfolding of the connector. Especially, the for example essentially planar inner object surface of at least one of the objects may form an abutment surface preventing disassembling by unfolding of the connector.

In embodiments, the connector is folded from a sheet, such as a metal sheet. The configuration of the connector may be such that a first and/or second object when extending along one of the large surfaces of the connector and being bonded thereto prevents unfolding of the sheet.

In a group of embodiments, the sheet portions of the connector are stabilized by a foldover portion, i.e. a portion extending from one of the sheet portions (for example the second sheet portion) and being folded over the outer surface of the other sheet portion (for example first sheet portion). In a sub-group of embodiments, the other (for example first) sheet portion is provided with a receiving indentation receiving the foldover portion so that the foldover portion does not add to the thickness of the connector or does so to a lesser extent than if no such receiving indentation was present. Such foldover portion may especially be folded over the respective (for example first) sheet portion from an edge different from the edge along which it is connected to the other sheet portion, whereby the foldover portion ensures a self-stabilizing configuration in the above sense.

In another group of embodiments, one of the sheet portions has a plurality of sections extending from different edges, whereby the configuration is self-stabilizing also without any (optionally nevertheless present) foldover portions.

A condition for such a self-stabilizing configuration to be possible may be that a large surface of the connector that comes into contact with the inner surface of one of the objects is formed from different portions folded from the sheet portion constituting the other large surface, namely from portions folded into different folding directions. Different folding directions are especially present if the respective folding is done along non-parallel folding axes or, in case of parallel folding axes, into opposite directions.

The self-stabilizing configuration especially ensures an out-of-plane rigidity and a stability against tilting movements between the first and second objects even if the shape of the first/second movements would allow such tilting movement.

A self-stabilizing configuration as described herein may also be an option for a connector with at least one first attachment portion and at least one second attachment portion, which connector does not comprise a spacer.

Depending on the application, it may be desired that the stability against relative movements in in-plane (x-y-) directions are not maximized but adapted to specific requirements. For example, some elasticity with respect to in-plane movements may be desired to compensate for different coefficients of thermal expansion or to absorb kinetic energy by allowing for a plastic and/or elastic deformation of the sheet material for example in the event of a crash situation. Such absorption of kinetic energy will lead to a temporary and/or permanent deformation without the first and second objects being entirely disconnected, whereby the connection in the herein described manner may be a security feature, for example in vehicles or airplanes.

In accordance with a group of embodiments, therefore, a section that connects the first and second sheet portions, therefore, may be provided with at least one cutout. Such connecting section may comprise a fold that connects the first and second sheet portions, or may comprise a foldover bridge that connects a foldover portion with the sheet portion from which it extends. A cutout makes the connection between the first and second sheet portions more pliant in a targeted manner. The location and extension of the fold(s) and foldover portions as well as, if applicable, the shape, size and distribution of such cutout(s) may be adapted to specific requirements. The connector may be configured to have a greater stiffness with respect to shear in one in-plane dimension compared to the other in-plane dimension. With cutouts that are elongate and at an angle to the z-direction (the direction perpendicular to the sheet planes), it is even possible to produce asymmetry between opposing in-plane directions.

The method comprises the further step of providing the first and second objects, wherein both, the first object and the second object comprise thermoplastic material.

The first and second objects and the connector are positioned relative to each other so that the connector is placed between the first and second objects. Then, the first and second objects are pressed against each other while mechanical vibration energy impinges on the first and/or second object until a first flow portion of thermoplastic material of the first object in contact with the first attachment portion(s) and a second flow portion of thermoplastic material in contact with the second attachment portion(s) become flowable allowing the respective attachment portions to be pressed into material of the first and second object, respectively. After re-solidification of the flow portions, a positive-fit connection between the first and second objects via the connector results.

In addition to comprising a spacer, the connector may comprise a material connection, such as a spot weld connection or solder (for example spot solder) connection or glue (for example spot glue) connection, and/or a positive fit and/or interference fit connection, such as a clinching or clipping connection, between the first and second sheet portions. Comprising such a spot weld or solder or glue connection etc. between first and second sheet portions may also be an option for a connector with at least one first attachment portion and at least one second attachment portion, which connector does not comprise a spacer.

Such spot weld and/or solder, glue connection may for example be located at an in-plane position opposite a fold that connects the first and second sheet portions together.

The at least one spot weld and/or solder glue a connection may be an indirect connection via the spacer. However, the connection may also be a direct connection.

In embodiments, the connector may comprise a shape that is not-rectangular, especially adapted to specific requirements. For example, the connector may be instead of being rectangular form at least one arc to follow a contour of the objects to be fastened to each other, or of a part thereof.

The following options may apply:
The step of pressing may be carried out until surface of first/second object abuts a flat portion of the connector, namely the outer surface of the first/second sheet portion from which the attachment portion(s) protrude(s). Thereby, a width of a gap between the first and second object is precisely defined to amount to the cumulated thicknesses of the first and second sheet portions and the spacer.
An adhesive may be placed between the first and second objects at a position different from the position of the connector. It is one important advantage of the approach according to embodiments of the invention that a glue gap of well-defined width is created, without the necessity of providing surface structures of the first/second object (such as indentations) for accommodating the glue. Especially, the glue may be applied to a position where in the assembled state both, the first and second objects are flat and level with the surface portions between which the connector is arranged.

Especially, if two objects are fastened to each other by an adhesive, often the waiting time until the adhesive connection is sufficiently strong and the lack of stability of the connection therebefore is an issue. This issue is even more severe if the adhesive connection and hence the thickness of an applied adhesive portion have to be comparably thick, for example so that the connection exhibits a residual flexibility necessary for compensating different thermal expansion behaviors if necessary. Similarly, thick layers of adhesive are in many situations necessary if the adhesive has the additional function of sealing. Often one- or two-component Polyurethane adhesives are used for such purposes.

Embodiments of the present invention, therefore make a combination of the securing approach according to the invention with applying an adhesive having a predetermined thickness possible. Due to the connection via the connector, the assembly of the first and second objects with the connector and the adhesive between them may be subject to further processing steps without any waiting time for the adhesive to cure.

In addition or as an alternative, the adhesive or a portion thereof may be used as a sealant around the connector, for example to prevent any corrosion.

The connector, if it does not comprise a separate spacer object of the above-discussed kind, may be one-piece and formed by a contiguous sheet material for example a metal sheet. Especially, in any embodiment, the first and second sheet portions may be portions of a contiguous sheet of folded sheet material.

Especially if the spacer is a separate spacer object, the method may comprise the onsite adjustment of a connector width w. Then, the method may comprise providing a connector part comprising the first and second sheet portions and having an initial width, provisionally arranging the first and second object and the connector relative to one another, determining a desired connector width based on a dimension of this resulting arrangement, choosing a spacer object out of a plurality of available spacer objects, inserting this chosen spacer between the sheet portions and carrying out the subsequent pressing and vibration energy coupling step that, depending on a width of the chosen spacer object, may comprise deforming, by the pressing force, the connector part to have a final width that is smaller than the initial width.

Pressing and coupling the vibration energy into the first and/or second object may take place simultaneously, meaning that at least for some time both, the pressing force and the mechanical vibrations act. This does not, however, imply that the pressing force and the vibrations start and end at the same time.

Rather, especially the pressing force may optionally set in prior to the vibrations or possibly also after onset of the vibrations.

In embodiments, the pressing force may be maintained until the flow portions have re-solidified at least to some extent to prevent a spring-back effect. This may for example be advantageous in situations in which a spring-back-effect would be caused by an elastic deformation of the first object and/or the second object or by an elastic compression behavior of an adhesive between the first and second objects.

In other embodiments, especially embodiments without any adhesive, it may be advantageous to stop the pressing force when the vibrations stop, so that the system may relax prior to re-solidification. Thereby, internal stress in the first and second objects may be minimized, so that object deformation is prevented.

For applying a counter force to the pressing force, the respective other object may be placed against a support, for example a non-vibrating support. In embodiments, this other (for example second) object is placed against a support with no elastic or yielding elements between the support and the second object, so that the support rigidly supports the second object. Alternatively, vibrations are coupled into the assembly from both sides, i.e. sonotrodes act on both, the first and the second objects.

The present invention also concerns a connector adapted for carrying out the method according to any embodiment of the invention. The connector features described in this text when describing the method generally are possible features of the connector according to the present invention, and features of the connector according to the present invention described in this text are possible features of connectors used in the method according to the invention.

The invention even more concerns an apparatus comprising a source of mechanical vibration and being configured and/or programmed to carry out the method according to any embodiment of the present invention. Moreover, the invention concerns a set that comprises such apparatus and at least one connector.

Optionally, in addition to the mechanical vibration energy, further energy may be coupled into the assembly. In an example, the first and/or second object and/or the connector may be pre-heated by IR irradiation, induction (as far as having an electrically conducting component), a hot air stream, etc. In addition or as an alternative, the thermoplastic material of the first and/or second object may be pre-heated locally near the interface to the edge, for example by electromagnetic heating as described WO 2017/015 769, by irradiation, etc. For example, for electromagnetic heating as described in WO 2017/015 769, the thermoplastic material in the attachment zone may be provided with a magnetic dopant. In embodiments in which the connector is metallic, such magnetic dopant may be not necessary, since impinging electromagnetic energy may be absorbed directly by the connector, whereby the connector is pre-heated.

The first/second flow portion of the thermoplastic material is the portion of the thermoplastic material that during the process and due to the effect of the mechanical vibration is caused to be liquefied and to flow. The respective flow portion does not have to be one-piece but may comprise parts separate from each other.

In this text, the term “sheet plane” denotes the plane/surface defined by the shape of the generally planar (first, second) sheet portion, especially in a region around the edge, for example around the perforation (if any). The sheet plane may be planar in the sense of extending straight into two dimensions. Alternatively, the sheet plane may be curved and thereby follow a more complex 3D shape, for example if the first and second objects have complex surface shapes adapted to each other, for example as belonging to a body of a vehicle or aircraft.

In a group of embodiments, the first object and/or the second object comprises a structured contact side that comprises the thermoplastic material. The contact side is the side of the first object that is brought into contact with connector for the connecting. The fact that the contact side is structured means that it is different from just being flat and even and that it comprises protrusions/indentations. For example, it may comprise a pattern of ridges and grooves, for example a regular pattern.

Generally, the first and second objects are construction components (construction elements) in a broad sense of the word, i.e. elements that are used in any field of mechanical engineering and construction, for example automotive engineering, aircraft construction, shipbuilding, building construction, machine construction, toy construction etc. Generally, the first and second objects as well as a connector piece (if applicable) will all be artificial, man-made objects. The use of natural material such as wood-based material in the first and/or second object is thereby not excluded.

Turning back to the thermoplastic material(s) of the first object and of the second object, in this text the expression “thermoplastic material being capable of being made flowable e.g. by mechanical vibration” or in short “liquefiable thermoplastic material” or “liquefiable material” or “thermoplastic” is used for describing a material comprising at least one thermoplastic component, which material becomes liquid (flowable) when heated, in particular when heated through friction i.e. when arranged at one of a pair of surfaces (contact faces) being in contact with each other and vibrationally moved relative to each other, wherein the frequency of the vibration has the properties discussed hereinbefore. In some situations, for example if the first object itself has to carry substantial loads, it may be advantageous if the material has an elasticity coefficient of more than 0.5 GPa. In other embodiments, the elasticity coefficient may be below this value, as the vibration conducting properties of the first object thermoplastic material do not play a role in the process. In special embodiments, the thermoplastic material therefore may even comprise a thermoplastic elastomer.

Thermoplastic materials are well-known in the automotive and aviation industry. For the purpose of the method according to the present invention, especially thermoplastic materials known for applications in these industries may be used.

The thermoplastic materials of the first and second objects may be identical or may be different. They may be capable of being welded together or not.

A thermoplastic material suitable for the method according to the invention is solid at room temperature (or at a temperature at which the method is carried out). It preferably comprises a polymeric phase (especially C, P, S or Si chain based) that transforms from solid into liquid or flowable above a critical temperature range, for example by melting, and re-transforms into a solid material when again cooled below the critical temperature range, for example by crystallization, whereby the viscosity of the solid phase is several orders of magnitude (at least three orders of magnitude) higher than of the liquid phase. The thermoplastic material will generally comprise a polymeric component that is not cross-linked covalently or cross-linked in a manner that the cross-linking bonds open reversibly upon heating to or above a melting temperature range. The polymer material may further comprise a filler, e.g. fibres or particles of material which has no thermoplastic properties or has thermoplastic properties including a melting temperature range which is considerably higher than the melting temperature range of the basic polymer.

In this text, generally a “non-liquefiable” or “not liquefiable” material is a material that does not liquefy at temperatures reached during the process, thus especially at temperatures at which the thermoplastic material is liquefied. This does not exclude the possibility that the material would be capable of liquefying at temperatures that are not reached during the process, generally far (for example by at least 80° C.) above a liquefaction temperature (melting temperature for crystalline polymers for amorphous thermoplastics a temperature above the glass transition temperature at which the becomes sufficiently flowable, sometimes referred to as the ‘flow temperature’ (sometimes defined as the lowest temperature at which extrusion is possible), for example the temperature at which the viscosity drops to below 10⁴ Pa*s (in embodiments, especially with polymers substantially without fiber reinforcement, to below 10³ Pa*s)), of the thermoplastic material. For example, the non-liquefiable material may be a metal, such as aluminum or steel, or wood, or a hard plastic, for example a reinforced or not reinforced thermosetting polymer or a reinforced or not reinforced thermoplastic with a melting temperature (and/or glass transition temperature) considerably higher than the melting temperature/glass transition temperature of the liquefiable part, for example with a melting temperature and/or glass transition temperature higher by at least 50° C. or 80° C. or 100° C.

In this text, “melting temperature” is sometimes used to refer to the named liquefaction temperature at which the thermoplastic material becomes sufficiently flowable, i.e. the conventionally defined melting temperature for crystalline polymers and the temperature above the glass transition temperature at which the thermoplastic material becomes flowable sufficiently for extrusion.

Specific embodiments of thermoplastic materials are: Polyetherketone (PEEK), polyesters, such as polybutylene terephthalate (PBT) or Polyethylenterephthalat (PET), Polyetherimide, a polyamide, for example Polyamide 12, Polyamide 11, Polyamide 6, or Polyamide 66, Polymethylmethacrylate (PMMA), Polyoxymethylene, or polycarbonateurethane, a polycarbonate or a polyester carbonate, or also an acrylonitrile butadiene styrene (ABS), an Acrylester-Styrol-Acrylnitril (ASA), Styrene-acrylonitrile, polyvinyl chloride, polyethylene, polypropylene, and polystyrene, or copolymers or mixtures of these.

In addition to the thermoplastic polymer, the thermoplastic material may also comprise a suitable filler, for example reinforcing fibers, such as glass and/or carbon fibers. The fibers may be short fibers. Long fibers or continuous fibers may be used also, especially, but not only, for portions of the first and/or of the second object that are not liquefied during the process. In case long fibers or continuous fibers are used for portions that become liquefied, fibers may be cut through during the process, which however is not necessarily a problem.

The fiber material (if any) may be any material known for fiber reinforcement, especially carbon, glass, Kevlar, ceramic, e.g. mullite, silicon carbide or silicon nitride, high-strength polyethylene (Dyneema), etc..

Other fillers, not having the shapes of fibers, are also possible, for example powder particles.

Mechanical vibration or oscillation suitable for embodiments of the method according to the invention has preferably a frequency between 2 and 200 kHz (even more preferably between 10 and 100 kHz, or between 20 and 40 kHz) and a vibration energy of 0.2 to 20 W per square millimeter of active surface.

In many embodiments, especially embodiments that comprise coupling the vibration into the first object, the vibrating tool (e.g. sonotrode) is e.g. designed such that its contact face oscillates predominantly in the direction of the tool axis (longitudinal vibration), the tool axis corresponding to the axis along which the first object and second objects are moved relative to one another by the effect of the energy input and pressing force when the attachment portions are forced into material of the first object and second object, respectively) and with an amplitude of between 1 and 100 µm, preferably around 30 to 60 µm. Such preferred vibration is e.g. produced by ultrasonic devices as e.g. known from ultrasonic welding.

Depending on the application, a vibration power (more specifically: the electrical power by which an ultrasonic transducer is powered) may be at least 100 W, at least 200 W, at least 300 W, at least 500 W, at least 1000 W or at least 2000 W.

### BRIEF DESCRIPTION OF THE DRAWINGS

In the following, ways to carry out the invention and embodiments are described referring to drawings. The drawings are all schematical and not to scale. In the drawings, same reference numerals refer to same or analogous elements. The drawings show:

FIG. 1 In section, an arrangement of a first object, a second object, a connector and an adhesive, pressed together between a sonotrode and a counter element;

FIG. 2 the arrangement of FIG. 1 after the process;

FIGS. 3, 4 views of a connector (not according to the claimed invention);

FIGS. 5, 6 views of another connector (not according to the claimed invention);

FIGS. 7, 8 views of a sheet piece for forming a connector during a folding process (not according to the claimed invention);;

FIG. 9 a further arrangement of a first object, a second object, a connector and an adhesive;

FIGS. 10-11 views of further connectors shown in section (not according to the claimed invention);;

FIGS. 12, 13 views of connectors;

FIGS. 14-16 views of an even further connector during different stages of its manufacturing;

FIGS. 17-22 views of yet further connectors; and

FIG. 23 in section, an arrangement of a first object, a second object and a connector after the process.

### DESCRIPTION OF THE PREFERRED EMBODIMENTS

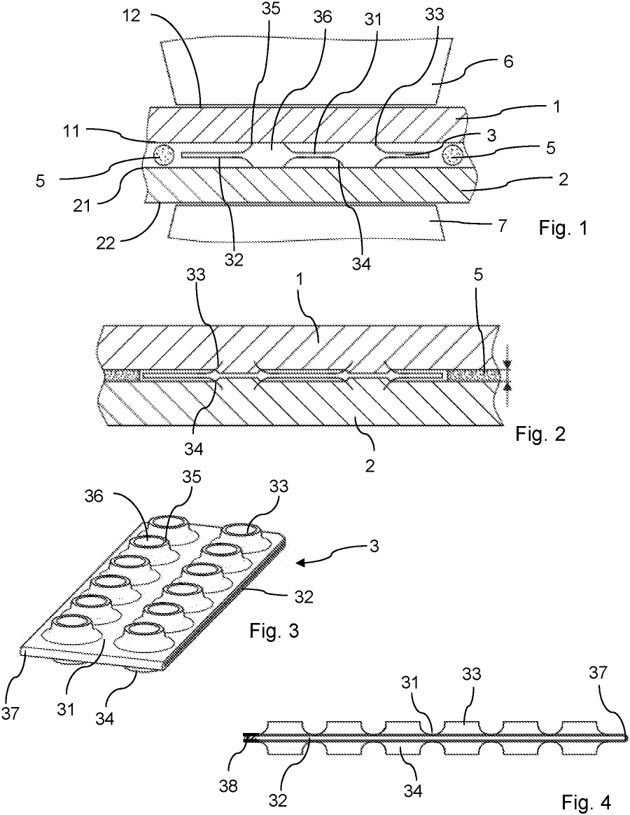

FIG. 1 illustrates the principle of bonding a first object and a second object together by means of a connector that has outwardly protruding attachment portions forming edges. The figure shows an arrangement of a first object 1 comprising a thermoplastic material, a second object 2 also comprising a thermoplastic material, and a connector 3, the connector arranged between the inner object surfaces 11, 21 of the first and second object. Also an adhesive 5 is arranged between the inner object surface 11 of the first object 1 and the inner object surface 21 of the second object. The adhesive 5 is in an uncured state.

In the depicted embodiment, the first and second objects 1, 2 are shown as plates of the thermoplastic material. Generally, it is sufficient if the first and second objects each have a section comprising the thermoplastic material, the section comprising the respective inner object surfaces 11, 21. The first objects may consist of such section or may comprise further sections of other materials, depending on their function.

The thermoplastic materials of the first and second objects 1, 2 may be identical or may be different.

The first and second objects 1, 2 each form an outer object surface 12, 22 that is approximately opposite the respective inner object surface 11, 21 and serves for applying the force for pressing the first and second objects against each other. At least one of the outer object surfaces 12, 22 further serves for coupling the mechanical vibration energy into the assembly. The respective outer object surface may be approximately parallel to the inner object surface. It is, however, also possible that the outer object surfaces have different and/or more complex shapes.

The connector 3 has a first sheet portion 31 having a plurality of first attachment portions 33 and a second sheet portion 32 having a plurality of second attachment portions 34. The attachment portions 33, 34 are formed by outwardly bent portions of the sheet material, these outwardly bent portions extending around an opening 36 and ending in an edge 35.

Generally, (this pertains to all embodiments), the connector may be formed of a metal sheet. A particularly suitable material is steel. Steel has a high modulus of elasticity, so that the sheet can be thin and light. It allows large deformation and maintains its rigidity after large deformation. For embodiments with a direct connection between portions or parts (such as a spot weld connection), it has a high weldability.

In the depicted configuration, a sonotrode 6 is used for coupling the vibration energy and a pressing force into the assembly, wherein the assembly is pressed against a counter element 7, i.e. the pressing force is applied between the sonotrode 6 and the counter element 7. In alternative embodiments, the counter element 7 is replaced by a second sonotrode, whereby the mechanical vibration energy is coupled into the assembly from both sides.

As an effect of the mechanical vibration energy input and the pressing force, with the edges 35 of the attachment portions 33, 34 being pressed against the thermoplastic material of the first/second object, energy absorption at the locations where the thermoplastic materials is in physical contact with the connector causes local heating and softening/making flowable of the thermoplastic material, so that as a consequence of this softening and the pressing force the respective attachment portions are pressed into the material of the first/second object, respectively. After re-solidification, a fixation between the first and second objects via the connector 3 results in that both, the first and second objects are secured to the connector 3 by a positive fit connection (FIG. 2). The principle of a positive fit connection between a sheet-like object (such as the present connector 3) having suitable attachment portions and am object having a thermoplastic material (such as the present first/second objects) is described in WO 2017/055 548.

The process including the re-solidification of the flow portion of the thermoplastic material may be relatively quick (for example a few seconds). It ensures a fixation of the first and second objects with respect to each other, with a gap between them, a width w of the gap being defined by properties of the connector, as explained in more detail hereinafter. The adhesive 5 that at least partially fills the gap may take more time to cure. Because of the fixation via the connector, during this curing time the assembly may be subject to further processing steps, including for example assembly with further objects. Thus, the approach according to embodiments of the present invention ensures that processing/assembly is not delayed by the time it takes the adhesive to cure, so that the approach may bring about substantial advantages in a manufacturing line.

FIGS. 3 and 4 show a connector 3 of which the first sheet portion 31 and a second sheet portion 32 lie immediately against each other, i.e. the inner surfaces of the respective sheet portions are in physical contact. The width w of the gap between the first and second objects thus may especially be the cumulated thickness of the first and second sheet portions. The sheet portions both belong to a common folded metal sheet (fold 37). Opposite the fold 37, the sheet portions are connected by a spot weld or glue or solder connection 38.

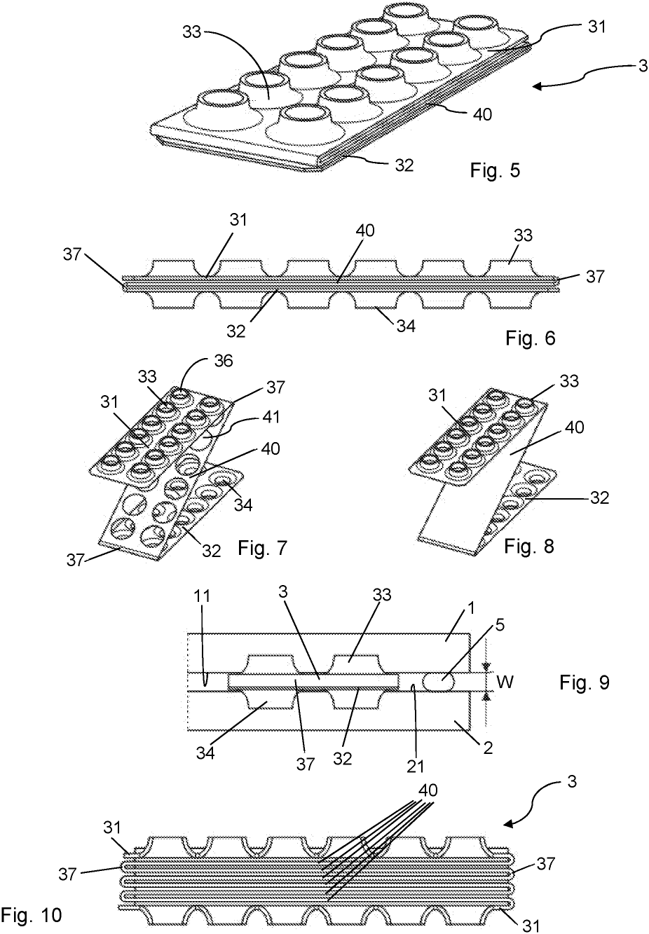

In addition to embodiments in which a small gap as illustrated with respect to FIGS. 1-4 is sufficient, it is also proposed to configure the connector to define a wider gap. A first possibility to do so is to increase the thickness of the sheet portion material. However, often this is not advantageous. According to an alternative option, the connector may comprise a spacer. FIGS. 5-8 illustrate the possibility of a spacer being constituted by a spacer sheet portion 40. The connector in this is folded (folds 37) from a sheet into three sections of approximately same areas, the outer two sections forming the first sheet portion 31 and the second sheet portion 32, and the middle section forming the spacer sheet portions. Other configurations, for example with the spacer sheet portion formed by an outer section and the first and second sheet portions being folded over the spacer sheet portion are possible also.

In the embodiment of FIGS. 5-7, the spacer sheet portion 40 has spacer sheet openings 47 at the positions of the (aligned) openings 36 in the first and second sheet portions 31, 32, respectively, around which the attachment portions 33, 34 are present so that there is more volume for the flow portions of the thermoplastic material to evade. If the flow portions of material of the first and second objects are sufficiently large, this will allow a weld between the flow portions that causes an additional fastening effect between the first and second objects.

In the embodiment of FIG. 8, the spacer sheet portion 40 does not have such spacer sheet openings.

FIG. 9 shows an arrangement with the first and second object 1, 2 secured to each other by a connector similar to the one of FIGS. 5-8 (but with the folds 37 at narrow side edges). The width w of the gap is approximately three times the thickness of the sheet material from which the connector is manufactured. This width w in the case of essentially flat inner surfaces 11, 21 (attachment surfaces) of the first and second objects is also the width of the adhesive gap (adhesive 5).

In connectors of the kind depicted in FIGS. 5-9, the width of the gap is approximately three times the thickness of the sheet material from which the connector is manufactured. This concept may readily be extended to a larger number by providing a plurality of spacer sheet portions 40. In the embodiment of FIG. 10, the connector is depicted to have a total of six spacer sheet portions 40 by having a total of seven folds 37.

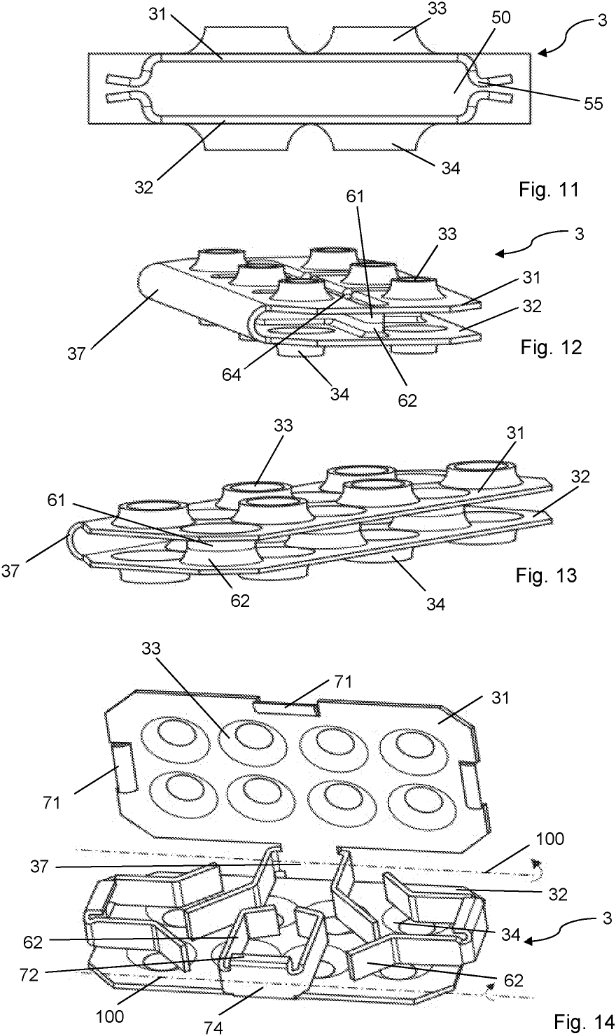

The connectors of FIGS. 3 and 4 on the one hand and of FIGS. 5-10 on the other hand have in common that the thickness of the metal sheet determines the width of the gap. The metal sheet thickness, however, is determined by requirements upon the connector, such as formability, sufficient stiffness, etc. The embodiments of FIGS. 5-10 also lead to connectors that are comparably heavyweight. It is therefore advantageous if the width of the gap can be designed independently of the thickness of the metal sheet. This is achieved by the spacers of the above-discussed kind. According to a first option (FIG. 11), therefore, the spacer is constituted by an initially separate spacer object. This has the advantage that the width of the gap can be chosen independently of the thickness of the sheet material. However, depending on the spacer material, the weight of the construction may still be an issue; also the spacer manufacturing process requires additional step and an additional part. The embodiments of FIGS. 12-23 having spacer portions formed from the sheet portions themselves solve also this issue.

FIG. 11 shows the concept of the connector having an initially separate spacer object 50 as an alternative - or in addition - to the spacer sheet portion(s). Such separate spacer object may be essentially plate shaped or have an other shape and may be of any suitable material, including the possibility of the spacer object being of a polymer material that is weldable to material of the first and/or second object.

It is especially possible that the spacer object 50 is inserted only after the first and second object and the connector are placed relative to one another, and that its dimensions may be chosen based on a desired width of a gap between the first and second object. The method may then comprise deforming, depending on a width of the chosen spacer object 50, the connector part to have a final width that is smaller than the initial width. This may comprise deforming a peripheral part 55 of the first and/or second sheet portion 31, 32.

FIG. 12 depicts a first example of a connector with a spacer portion of the first and/or second sheet portion being a part of the respective sheet portion that is bent inwardly for the other sheet portion or a spacer portion thereof to abut thereagainst. In the embodiment of FIG. 12, the first sheet portion 31 forms a first spacer portion 61 and the second sheet portion 32 forms a second spacer portion 62. The spacer portions 61, 62 are formed from the sheet material of the respective sheet portions 31, 32 by punching, the punch used forming an elongate indentation 64. In accordance with a first possibility, the used punch forms the indentation 64 may be an impression, i.e. an embossment. As an alternative the spacer could be formed by punching in a manner that a punching through hole is formed (i.e., in a piercing manner), with the spacer portion 61, 62 being a bead around the respective hole.,.

The spacer portions 61, 62 of the first and second sheet portions 31, 32 are aligned with each other and abut against each other.

To act against unfolding, the first and second sheet portions may be connected by a rigid bond, such as a material connection. For example, a spot weld in the pots formed by the spacer portions 61, 62 of the sheet portions, or a spot solder connection or spot glue connection between the abutting spacer portions may form such a rigid bond. In this, the rigid bond is indirect, i.e. via the spacer portions.

Also the embodiment of FIG. 13 comprises aligned spacer portions 61, 62 of the first and second sheet portion 31, 32 abutting against each other. Also in the embodiments of FIG. 13, the spacer portions 61, 62 may be or impressions, i.e. embossements or possibly, as an alternative, beads around a punched hole. In contrast to FIG. 12, the spacer portions have a shape and arrangement corresponding to the shape and arrangement of the attachment portions 33, 34 and in FIG. 13 are interleaved with them.

Like the embodiment of FIG. 12, the embodiment of FIG. 13 may comprise a rigid bond, for example between corresponding spacer portions 61, 62 of the first and second sheet portions.

The embodiments of FIGS. 12 and 13 are examples of connectors the spacer portions of which are arranged centrally in the first and/or second sheet portions and thereby require a disruption (punched hole; alternatively a cut or the like could serve as disruption) of the respective sheet portion. The embodiment of FIGS. 14-16 described hereinafter, in contrast, is an example of a connector with a peripheral spacer portion.

FIGS. 14-16 thus show a further embodiment with spacer portions formed from the sheet material of the sheet portions 62. The spacer portions are initially (blank shown in FIG. 16) arranged peripherally and are folded into the positions shown in FIG. 14. The connector also comprises a bridge portion 37 that after folding forms the fold, has a width corresponding to the width of the spacers and connects the first and second sheet portions 31, 32 together, as well as a foldover portion 72 (in the shown embodiment, there are three foldover portions 72) that is folded over a receiving indentation 71 for stabilizing the connector in the folded state. The foldover portion 72 is connected to the second sheet portion 32 via a foldover bridge 74 that also has a width approximately corresponding to the width of the spacers.

The connection between the foldover portion 72 and the first sheet portion may optionally be a latching connection, wherein the first sheet portion may be latched down onto into the configuration where it abuts against the spacer portions. Compared to the embodiments with a foldover portion described hereinafter, such latching connection may be relatively stiff.

In the concept of FIGS. 14-16, the entire blank defining all dimensions may be manufactured in one manufacturing step, for example by laser cutting or waterjet cutting. The freely choosable width wₛ of thus manufactured structures 62 defines the spacer z extension and thus ultimately the width w of the gap. Further advantages are that the spacer structures may be configured arranged independently of the attachment portions 33, 34, so that the design degrees of freedom are maximized. Also, no embossing step is required. A disadvantage is the relatively sophisticated folding process, compared to the embodiments of FIGS. 13 and 13.

Like the embodiments described hereinafter referring to FIGS. 18-23, the connector of Figs, 14-16 does not require a rigid bond between the sheet portions and may therefore have some elasticity with respect to deformations in in-plane directions.

FIG. 17 illustrates – for an example of a connector based on the principle described referring to FIGS. 12 and 13, especially with a rigid bond for acting against unfolding – the possibility of shaping the connector in a manner that deviates from a simply rectangular shape. The connector of FIG. 17 is essentially arc shape, with a comparably short (in in-plane dimensions) fold 37 allowing some flexibility with respect to in-plane displacements of the relative positions of the first and second sheet portions 31, 32. More in general, the shape of the connector may be adapted in view of dimensions of the objects to be connected as well as in view of flexibility requirements.

The connector 3 of FIG. 18 in contrast to the embodiment of FIGS. 14-16 has the following features that are independent of each other:
The connector has spacers formed by pairs of spacer portions 61, 62 formed by indentations in the first and second sheet portions 31, 32.
The fold 37 as arranged along a long edge (broad side edge) of the connector being essentially rectangular. This leads to enhanced stability with respect to certain in-plane relative movements (see also the discussion hereinafter).
The foldover portions 72 are folded over parts of the first sheet portion 31 that are not indented, i.e. the foldover portions protrude above the outer surface of the first sheet portion 31.

In the embodiment of FIG. 19, the foldover portion 72 extends along a long edge of the essentially rectangular connector. Also, the fold 37 has slit-shaped first cutouts 39. Similarly the foldover bridge 74 has slit-shaped second cutouts 75.

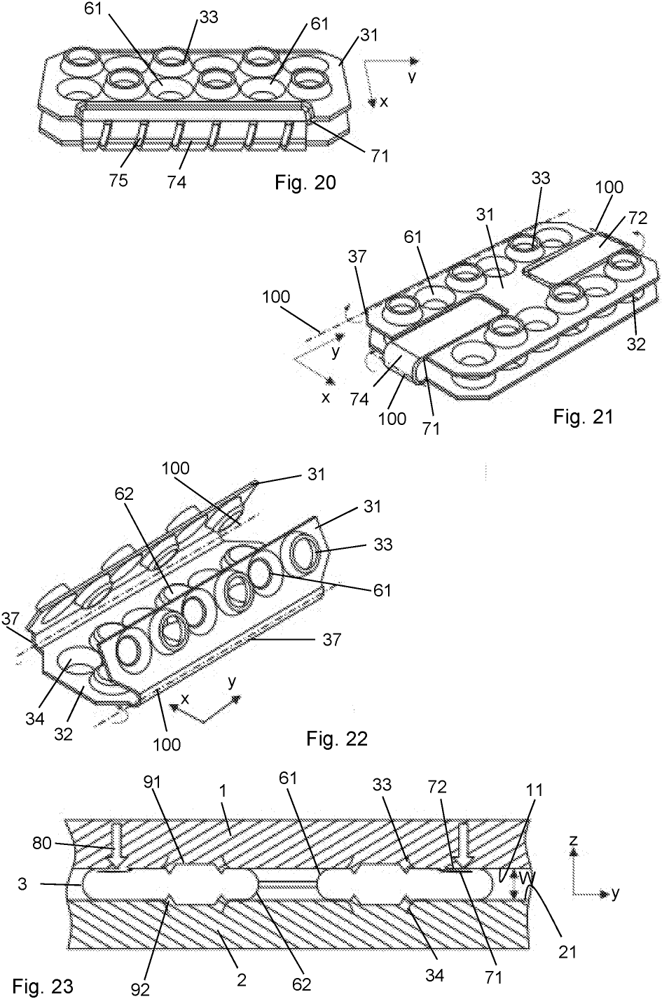

The embodiment of FIG. 20 is distinct from the embodiment of FIG. 19 by the following two independent features:
The foldover portion 72 is folded over an indented portion of the first sheet portion so that the outer surface of the foldover portion is approximately flush with the outer surface of the first sheet portion.
The second cutouts 75 (and/or the first cutouts 39) are inclined with respect to directions perpendicular to the sheet planes.

The embodiment of FIG. 21 has two foldover portions 72 that are relatively narrow and extend from the narrow side edges of the second sheet portion 32.

In the embodiment of FIG. 22, the first sheet portion 31 is constituted by two sections, each extending from a broad side edge. Thus, instead of being connected by one fold 37 and stabilized by a foldover portion, the first and second sheet portions are connected by two folds 37 extending along opposing edges.

Embodiments with foldover portions or embodiments of the kind shown in FIG. 22 apply the principle of self-stabilization. This principle is illustrated, for the example of a connector having two foldover portions extending from opposing edges of the second sheet portion 32, like embodiments of FIGS. 14-16 and 21, in FIG. 23. FIG. 23 shows the assembly of the first object 1, the second object 2 and the connector 3 after the bonding process. The connector has at least one spacer formed by two spacer portions 61, 62 and defines a gap with a width w between the inner surfaces of the objects. As illustrated by the block arrows 81, the first object 1 after the bonding process defines an abutment for the foldover portions 72 preventing them from flexing back. Therefore, the assembly is stable also with respect to forces pulling the first and second objects 1, 2, apart, i.e. forces in z direction, just due to the folding configuration and the bond of the first and second object to the first and second sheet plane, respectively.

More specifically, in a self-stabilizing configuration the resistance against pulling forces pulling the first and second objects apart from each other is higher than just the resistance of the sheet portions and possible foldover portions against bending. A self-stabilizing configuration uses the – usually very high – stability of a sheet material against in-plane deformations to prevent unfolding/out-of-plane deformations from occurring.

FIG. 23 also illustrates re-solidified flow portions 91, 92 of the first object and second -object-respectively, whereby the inner surfaces 11, 12 of the first and second objects in a vicinity of the attachment portions 33, 34 may be less smooth than originally.

A condition for such a self-stabilizing configuration to be possible may be that a large surface of the connector that comes into contact with the inner surface of one of the objects (the upper surface in a the embodiments of FIGS. 14-16 and 18-23) is formed from portions folded from the sheet portion constituting the other large surface into different folding directions. Different folding directions are especially present if the respective folding is done along non-parallel folding axes or, in case of parallel folding axes, into opposite directions. This is illustrated in FIGS. 14, 21 and 22 where the folding axes 100 are illustrated.

In FIG. 14, the folding axis of the first sheet portion (the upper folding axis 100 in FIG. 14) and of the foldover portion 72 are parallel along opposite edges of the connector but with the folding being in opposite directions, as schematically illustrated by the arrows.

In FIG. 21, the folding axes 100 of the foldover portions 72 are parallel to each other, with opposite folding directions, and the folding axis 100 of the first sheet portion 31 with respect to the second sheet portion 32 is at an angle of 90° to the folding axes of the foldover portions. For the self-stabilizing effect, in this configuration, it would be sufficient if just one of the foldover portions 72 was present.

In FIG. 22, the folding axes 100 of the two sections of the first sheet portion are parallel, namely along the broad side edges, with opposite folding directions. In such a configuration, the self-stabilizing effect arises even without any foldover portion.

The connector 3 may be designed to have tailor-made properties with respect to shear forces, i.e. translational and/or rotational in-plane forces of the two objects relative to one another. In-plane forces in the present context are forces parallel to the sheet planes, i.e. parallel to the x-y-plane in the coordinate system used (see for example FIGS. 20-23).

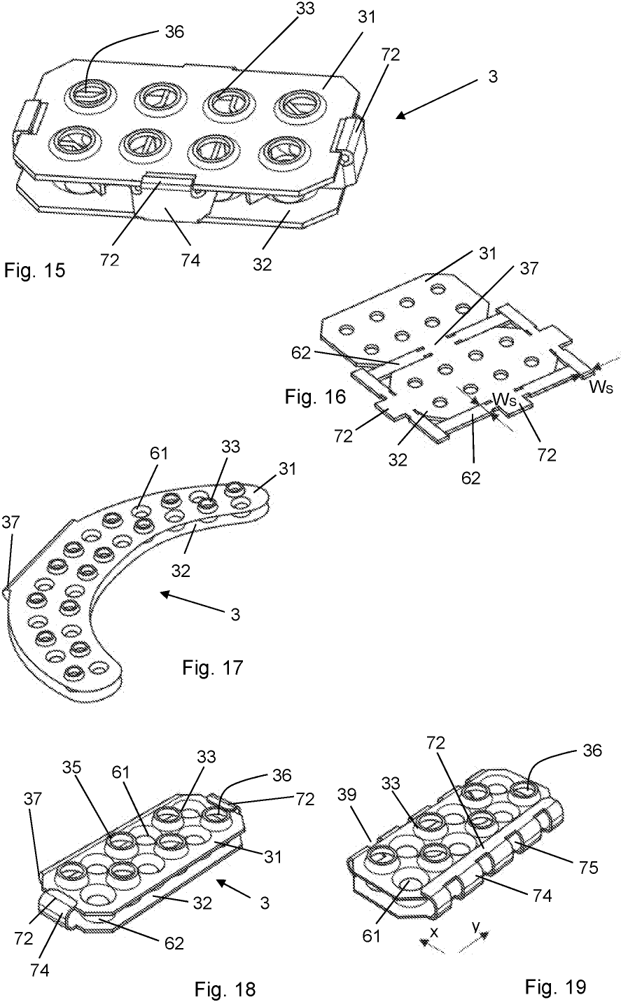

Parameters that may be used to influence the stiffness with respect to in-plane forces include:
The location of the fold (for example along the broad side or narrow side).
The extension (length) of the fold; compare for example FIGS. 15 and 18 with each other, showing embodiments with a short fold and a long fold, respectively.
The number of folds (the embodiment of FIG. 22 has two folds, the other shown embodiments have one fold). The configuration of FIG. 22 is an example of a configuration having large stiffness with respect to shear forces y-directions and a much smaller stiffness with respect to shear forces in x-directions. This is because of the location of the folds (along the broad side, parallel to the y-diretion), the length of the folds (long) and because of the two-fold configuration characteristic for the embodiment of FIG. 22.
The number, location and size of foldover portions
The use of receiving indentations (receiving indentations enhance the stiffness)
The number, size and distribution of first and/or second cutouts. For example, the embodiment of FIG. 19 has, compared to the embodiment of FIG. 22, a reduced y-stiffness because of the cutouts 39, 75 as well as because it has just one fold and the foldover portion is not received in a receiving indentation.
Further measures (not shown in the figures) influencing the stiffness of the sheet portions themselves.
Finally, the rigid bonds, for example by welding/gluing/soldering or clinching, for example of embossed spacer portions, as described referring to FIGS. 12, 13, and 17 are structures influencing the stiffness with respect to in-plane forces. Especially, such rigid bonds make the connector relatively stiff by not allowing any relative in-plane movements between the sheet portions.

In all cases, the respective structure can be manufactured from a simple deformable sheet part, for example a metal sheet part. Thus an important advantage of embodiments of the invention – namely the possibility to manufacture the connector in a cost-efficient manner – is not impaired by measures for securing a tailor-made shear stiffness.

1-29. (canceled)

30. A method of mechanically securing a first object to a second object, the method comprising:
providing the first object comprising a thermoplastic material in a solid state and providing the second object comprising a thermoplastic material in a solid state;
providing a connector, the connector having a first sheet portion and a second sheet portion, wherein the first and second sheet portions have inner surfaces facing each other, wherein the first sheet portion has at least one outwardly protruding first attachment portion and the second sheet portion has at least one outwardly protruding second attachment portion, and wherein the connector has a spacer between the first and second sheet portions, wherein the spacer comprises a spacer portion of the first sheet portion being a part of the first sheet portion bent away from a sheet plane and/or a spacer portion of the second sheet portion being a part of the second sheet portion bent away from a sheet plane, the spacer defining a distance between the inner surfaces;
positioning the first object, the second object and the connector relative to one another so that the connector is placed between the first and second objects;
pressing the first and second objects against each other while the connector is between the first and second objects and while mechanical vibration energy is coupled into the first object or the second object or both, the first and second objects, until a first flow portion of thermoplastic material of the first object in contact with the first attachment portion and a second flow portion of thermoplastic material in contact with the second attachment portion become flowable, thereby allowing the first and second attachment portions to be pressed into material of the first and second object, respectively; and
causing the first and second flow portions to re-solidify, to create a positive-fit connection between the first object and the connector and a positive-fit connection between the second object and the connector.

31. The method according to claim 30, wherein the first attachment portion and/or the second attachment portion is an outwardly protruding portion of sheet material of the first and/or second sheet portion respectively, the outwardly protruding portion extending around an opening and ending in an edge.

32. The method according to claim 30, wherein the first sheet portion and the second sheet portion are portions of a contiguous sheet folded to comprise the first and second sheet portions, wherein the sheet preferably is a metal sheet.

33. The method according to claim 30, wherein the connector comprises a plurality of first attachment portions and a plurality of second attachment portions.

34. The method according to claim 30, wherein pressing the first and second objects against each other is carried out until inner surfaces of the first and second objects abut against a flat part of the first sheet portion and the second portion, respectively.

35. The method according to claim 30, further comprising applying an adhesive to the first object and/or to the second object prior to positioning the first object, the second object and the connector relative to one another, the adhesive being applied at a position that, after positioning the first object, the second object and the connector relative to one another, is different from the position at which the connector is located and is between the first and second objects.

36. The method according to claim 30, wherein the spacer portion or at least one of the spacer portions is a portion bent to have an angle of about 90° with respect to sheet planes of the first and second sheet portions and/or is an embossed portion of the first and/or second sheet portion.

37. The method according to claim 30, wherein the connector has a self-stabilizing configuration, whereby after creating the positive-fit connection with the first and second objects, an inner object surface of at least one of the first and second objects forms an abutment surface preventing unfolding of the connector, and
wherein the connector is a folded metal sheet, and the shape of the connector is such that the first and/or second object when extending along one of the large surfaces of the connector and being bonded thereto prevents unfolding of the metal sheet.

38. The method according to claim 37, wherein a large surface of the connector that comes into contact with the inner surface of one of the first and second objects comprises different portions folded from the sheet portion constituting the other large surface, namely from portions folded into different folding directions, wherein the different portions folded are folded along non-parallel folding axes and/or into opposite directions.

39. The method according to claim 30, wherein the first and second sheet portions of the connector are stabilized by a foldover portion, the foldover portion extending from one of the sheet portions and being folded over an outer surface of the other sheet portion, wherein the other sheet portion has a receiving indentation in the outer surface, the receiving indentation receiving the foldover portion.

40. The method according to claim 30, wherein the first sheet portion has a plurality of first sheet portion sections, each first sheet portion section connected to the second sheet portion by a fold, the folds running into different directions.

41. The method according to claim 30, wherein a section that connects the first and second sheet portions has at least one cutout.

42. A connector for carrying out a method according to claim 30, the connector having a first sheet portion and a second sheet portion, wherein the first and second sheet portions have inner surfaces facing each other, wherein the first sheet portion has at least one outwardly protruding first attachment portion and the second sheet portion has at least one outwardly protruding second attachment portion, and wherein the connector has a spacer between the first and second sheet portions, wherein the spacer comprises a spacer portion of the first sheet portion being a part of the first sheet portionbent away from a sheet plane and/or a spacer portion of the second sheet portion being a part of the second sheet portion bent away from a sheet plane, the spacer defining a distance between the inner surfaces.

43. The connector according to claim 42, wherein the first and second sheet portions each have a plurality of attachment portions, each attachment portion comprising an outwardly protruding portion of sheet material of the first and/or second sheet portion respectively, the outwardly protruding portion extending around an opening.

44. The connector according to claim 42, where the connector is constituted by a metal sheet folded to yield the first and second sheet portions, wherein the shape of the connector is such that an object abutment surface lying against a large surface of the connector and parallel thereto acts to prevent unfolding of the sheet.

45. The connector according to claim 44, further comprising at least one foldover portion being a portion extending from one of the sheet portions and being folded over an outer surface of the other sheet portion, wherein the other sheet portion preferably has a receiving indentation in the outer surface, the receiving indentation receiving the foldover portion.

46. The connector according to claim 44, wherein an outer large surface of the connector comprises different portions folded from the sheet portion constituting another, opposing large surface, namely from portions folded into different folding directions, wherein the different portions are folded along non-parallel folding axes and/or into opposite directions.

47. The connector according to claim 42, wherein the spacer portion or at least one of the spacer portions is a portion bent to have an angle of about 90° with respect to sheet planes of the first and second sheet portions, and/or is an embossed portion of the first and/or second sheet portion.

48. The connector according to claim 42, wherein the first sheet portions has a plurality of first sheet portion sections, each section connected to the second sheet portion by a fold, the folds running into different directions.

49. The connector according to claim 42, wherein a section that connects the first and second sheet portions has at least one cutout.
